(19) United States
(12) Patent Application Publication
(10) Pub. No.: US 2004/0023812 A1
(43) Pub. Date: Feb. 5, 2004

(54) Hydraulic Fracturing Method

(75) Inventors: Kevin England, Houston, TX (US); Sylvie Daniel, Jouy en Josas (FR)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(73) Assignee: SCHLUMBERGER TECHNOLOGY CORPORATION, Sugar Land, TX (US)

(21) Appl. No.: 10/249,943

(22) Filed: May 21, 2003

Related U.S. Application Data
(63) Continuation-in-part of application No. 09/918,264, filed on Jul. 30, 2001.
(63) Continuation-in-part of application No. 09/667,073, filed on Sep. 21, 2000, now abandoned.
(60) Provisional application No. 60/382,179, filed on May 21, 2002.

(51) Int. Cl. C09K 7/00

(52) U.S. Cl. 507/100

(57) ABSTRACT

The invention relates to a method of fracturing a subterranean formation including injecting into a wellbore a fracturing fluid based on a liquid medium having a density higher than 1.3 g/cm³, thereby allowing the use of a surface pressure at least 10% smaller than the surface pressure required with a fracturing fluid based on a liquid medium having a density of about 1 g/cm³.

### CROSS REFERENCE TO RELATED APPLICATIONS

This application is a Continuation-in-Part of U.S. patent application Ser. No. 09/918,264, filed on Jul. 30, 2001, itself a Continuation-in-Part of U.S. patent application Ser. No. 09/667,073, filed on Sep. 21, 2000. This application further claims the priority of the U.S. Provisional Patent Application 60/382,179 filed on May 21, 2002.

### BACKGROUND OF INVENTION

This invention relates generally to the art of hydraulic fracturing in subterranean formations and more particularly to a method and means for optimizing fracture treatment.

Hydrocarbons (oil, natural gas, etc.) are obtained from a subterranean geological formation (i.e., a “reservoir”) by drilling a well that penetrates the hydrocarbon-bearing formation. This provides a partial flowpath for the hydrocarbon to reach the surface. In order for the hydrocarbon to be “produced,” that is travel from the formation to the wellbore (and ultimately to the surface), there must be a sufficiently unimpeded flowpath from the formation to the wellbore.

Hydraulic fracturing is a primary tool for improving well productivity by placing or extending channels from the wellbore to the reservoir. This operation is essentially performed by hydraulically injecting a fracturing fluid into a wellbore penetrating a subterranean formation and forcing the fracturing fluid against the formation strata by pressure. The formation strata or rock is forced to crack and fracture. Proppant is placed in the fracture to prevent the fracture from closing and thus, provide improved flow of the recoverable fluid, i.e., oil, gas or water.

Hydraulic fracturing for well stimulation relies on the ability to pump the fracturing fluid at a bottomhole pressure sufficient to overcome the formation in-situ stresses so that the rock can be cracked. Once a fracture is initiated, enough bottomhole pressure must be maintained to propagate the fracture further away from the wellbore and generate the necessary fracture width for it to be filled with the propping material that will keep the fracture open once the pumping has stopped. The initial breakdown pressure is usually higher than the minimum pressure needed to re-open the same fracture. This is due to the tectonic stress in the rock that has to be initially overcome. The minimum pressure needed to re-open the fracture after breakdown is called the fracture opening pressure. This pressure is usually slightly higher than the fracture closure pressure due to poroelastic effects and other factors due to the geologic setting. The fracture closure pressure is the pressure at which the fracture will close. Therefore, after the fracture is re-opened, the bottomhole pressure or BHP needs to be above the fracture closure pressure to successfully perform the fracturing treatment.

The effective bottomhole pressure is the sum of the surface pressure provided by the pumping equipment and the hydrostatic pressure, minus the pressure losses due to friction forces while the fluid passes through the surface and subterranean equipments such as pipes. The required bottomhole pressure is governed by the mechanical properties of the formation and is therefore an intangible parameter. To match the required and effective bottomhole pressure, the focus shall be on either increasing the surface pressure and/or the hydrostatic pressure or lowering the friction pressures.

The maximum surface pressure may be the limitation of the pumping equipment used to perform the hydraulic fracturing treatment and may be increased by either using different pumps with a higher-pressure capacity. Increasing the numbers of pumps, or utilization of pumps with a higher hydraulic horsepower (HHP) rating, is needed if the limitation is the amount of HHP needed to pump the fracturing treatment as designed. Obviously, this results in increased cost, not only equipment but also logistic and personal costs. Moreover, this option may simply not be available for instance on an offshore rigs or other situations where physical space may be limited. Regardless of the cost and availability of the equipment, an increased of the surface pressure may be also ruled out by the surface and/or subterranean equipment associated with the well. This is because the surface pressure is also limited based on the “weakest point” in the completion of the well, consisting of surface equipment for instance such as wellheads, blowout preventers, valves, tree-savers; casing and tubing properties (size, weight and grade), packers, etc.

Lowering the friction pressure is a main focus of the well services industry and also involves early planning during the well construction process by increasing the size (internal diameter) of the tubing or casing. Other fracturing designs options include pumping the fracturing fluid down the annulus instead of the smaller tubing, using lower pumping rates or maximizing the drag reduction properties of the fluid by adding friction reducer or delaying the crosslink time for polymer-based fluids for instance. Though dramatic progresses have been done in that area in recent years, there is a limit to the reduction that can be achieved that way since the friction pressure cannot be annihilated.

As mentioned above, the required bottomhole pressure is governed by the mechanical properties of the formation. In general, but not always, the deeper the well, the higher the needed bottomhole pressure to create a hydraulic fracture. As a rule of thumb, a bottomhole pressure of 0.75 psi is required by foot of depth (or in order words, about 17 With a focus towards deeper wells for low-permeability gas field development, and towards wells in deep water where friction pressure accounts for a larger part of the surface treating pressure, there is therefore a remaining need for fracturing processes that will allow achieving higher bottomhole pressure while keeping relatively low surface pressure.

### SUMMARY OF INVENTION

According to a first aspect of the present invention, a method of fracturing a subterranean formation is proposed that includes injecting into a wellbore a fracturing fluid based on a liquid medium having a density higher than 1.3³, thereby allowing the use of a surface pressure at least 10% less than the surface pressure required with a fracturing fluid based on a liquid medium having a density of about 1³.

The method of the invention is particularly useful for fracturing deep wells that require high bottomhole pressure at least during part of the treatment and makes possible the stimulation of wells previously eliminated as candidates due to surface pressure restrictions. In particular, the invention allows the use of standard equipment, that has an upper limit of typically about 15,000 or even of standard coiled tubing pumping unit that have an upper limit of typically about 7,000

Such a high density is obtained for instance by using a fracturing fluid whose viscosity is controlled through the addition of a viscoelastic surfactant compatible with high concentrations of salts, preferably such as a zwitterionic surfactant.

Zwitterionic surfactants suitable for carrying out the method of the present invention include mixture of amphoteric/zwitterionic surfactants and an organic acid, salt and/or inorganic salt as it is known from International Patent Publication WO The surfactants are for instance dihydroxyl alkyl glycinate, alkyl ampho acetate or propionate, alkyl betaine, alkyl amidopropyl betaine and alkylamino mono- or di-propionates derived from certain waxes, fats and oils. The surfactants are used in conjunction with an inorganic water-soluble salt or organic additive such as phthalic acid, salicylic acid or their salts. Amphoteric/zwitterionic surfactants, in particular those comprising a betaine moiety are useful at temperature up to about 175Â° C. and are therefore of particular interest for medium to high temperature wells.

According to one embodiment of the invention, the method of fracturing involves the use of a betaine that contains an oleyl acid amide group (including a C₁₇H₃₃ alkene tail group).

Yet a preferred embodiment of the present invention is a method of fracturing subterranean formation while maintaining lower surface pressure involving the use of a betaine that contains an erucic acid amide group (including a C₂₁H₄₁ alkene tail group). The surfactant may be further stabilized by the addition of an alcohol, and preferably methanol.

Yet another embodiment of the invention is a method of fracturing a subterranean formation at reduced surface pressure including injecting into a wellbore a fracturing fluid, based on a liquid medium having a density higher than 1.3³, thereby allowing the use of a surface pressure not greater than 15,000 psi during the whole injection, adding proppant and energizing the fluid to improve the clean-up. Foam or energized fluids are stable mixture of gas and liquid. They expand when they flow back from the well and therefore force the fluid out of the fracture, consequently ensuring an improved clean-up. Foam and energized fracturing fluids are generally described by their foam quality, i.e. the ratio of gas volume to the foam volume. If the foam quality is between 52% and 95%, the fluid is usually called foam. Above 95%, foam is generally changed to mist. In the present patent application, the term “energized fluid” is used however to describe any stable mixture of gas and liquid, whatever the foam quality is.

### BRIEF DESCRIPTION OF DRAWINGS

The above and further objects, features and advantages of the present invention will be better understood by reference to the appended detailed description, and to the drawings wherein:

FIG. 1 is the plot of hydrostatic pressure gradient versus fluid density;

FIG. 2 is a plot of viscosity versus temperature for three brines of different density consisting of aqueous solution of a betaine that contains a erucic acid amide group and mixture of calcium bromide/chloride salts;

FIG. 3 is a plot of viscosity versus temperature for four brines of different density consisting of aqueous solution of a betaine that contains an erucic acid amide group and mixture of zinc and calcium bromide salts;

FIG. 4 is a plot of viscosity versus temperature for four brines of different density consisting of aqueous solution of a betaine that contains an erucic acid amide group and mixture of zinc bromide, calcium bromide and calcium chloride salts;

FIG. 5 is a plot of the clean fluid friction data comparing a fluid made of a zwitterionic surfactant such as oleyl betaine in sodium bromide brine, a fluid made of the same zwitterionic surfactant in a mixture of calcium bromide and calcium chloride and a fluid consisting of a cationic surfactant in potassium chloride.

### DETAILED DESCRIPTION

In most cases, a hydraulic fracturing treatment consists in pumping a proppant-free viscous fluid, or pad, usually water with some high viscosity fluid additives, into a well faster than the fluid can escape into the formation so that the pressure rises and the rock breaks, creating artificial fracture and/or enlarging existing fracture. Then, a propping agent such as sand is added to the fluid to form a slurry that is pumped into the fracture to prevent it from closing when the pumping pressure is released. The proppant transport ability of a base fluid depends on the type of viscosifying additives added to the water base, on the density difference between the proppant and the water base carrier fluid and on the velocity of the slurry in the hydraulic fracture.

The downhole pressure required to crack the subterranean formation is function of the surface pressure, the weight of the hydraulic column (the hydrostatic pressure) and is reduced by the frictional pressure losses due in particular to the tubing and other downhole equipment and to the perforation friction pressure. In the key initial stage of a hydraulic fracturing treatment, the pumped fracturing fluid is proppant-free, and therefore the hydrostatic pressure is not enhanced by the weight of the proppant, typically consisting of sand or ceramic particles.

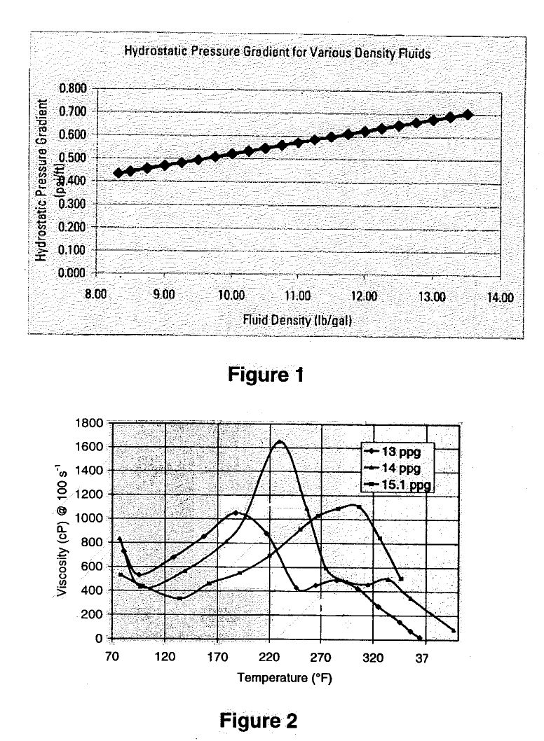

As shown in FIG. 1, where the hydrostatic pressure gradient (in psi per foot) is plotted versus the fluid density (in pounds per gallon), the hydrostatic pressure varies linearly with the fluid density. Therefore an increase of the fluid density results in an increase of the downhole pressure available for fracturing the formation without the need to increase the surface pressure.

Water-base fracturing fluids with water-soluble polymers added to make a viscosified solution are widely used in the art of fracturing. Since the late 1950s, more than half of the fracturing treatments are conducted with fluids comprising guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG). Crosslinking agents based on boron, titanium, zirconium or aluminum complexes are typically used to increase the effective molecular weight of the polymer and make them better suited for use in high-temperature wells.

To a smaller extent, cellulose derivatives such as hydroxyethylcellulose (HEC) or hydroxypropylcellulose (HPC), carboxymethylhydroxyethylcellulose (CMHEC) and carboxymethycellulose (CMC) are also used, with or without crosslinkers. Xanthan and scleroglucan, two biopolymers, have been shown to have excellent proppant-suspension ability even though they are more expensive than guar derivatives and therefore used less frequently. Polyacrylamide and polyacrylate polymers and copolymers are used typically for high-temperature applications and/or where friction reduction is required.

Though some attempts have been made in the past (see for instance U.S. Pat. Nos. 5,785,747 and 6,100,222), high-density brines comprising water-soluble polymers are typically not practicable due to adverse effect of brines on polymer hydration and gel stability.

Polymer-free, water-base fracturing fluids can be obtained using viscoelastic surfactants. These fluids are normally prepared by mixing in appropriate amounts of suitable surfactants such as anionic, cationic, nonionic and zwitterionic surfactants in aqueous solutions. The viscosity of viscoelastic surfactant fluids is attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscosity and elastic behavior.

Cationic viscoelastic surfactants—typically consisting of long-chain quaternary ammonium salts such as cetyltrimethylammonium bromide (CTAB) have been so far of primarily commercial interest in wellbore fluid. Common reagents that generate viscoelasticity in the surfactant solutions are salts such as ammonium chloride, potassium chloride, sodium chloride, sodium salicylate and sodium isocyanate and non-ionic organic molecules such as chloroform. The electrolyte content of surfactant solutions is also an important control on their viscoelastic behavior. Reference is made for example to U.S. Pat. No. 4,695,389, No. 4,725,372, No.No. 5,964,295, and No. 5,979,557. However, fluids comprising this type of cationic viscoelastic surfactants usually tend to lose viscosity at high brine concentration (10 pounds per gallon or more) and may be unstable in presence of divalent salts such as calcium bromide or calcium chloride. Therefore, these fluids have seen limited use as gravel-packing fluids or drilling fluids, or in other applications requiring high-density fluids to balance well pressure or to minimize surface treating pressure.

It is also known from International Patent Publication WO 98/56497, to impart viscoelastic properties using amphoteric/zwitterionic surfactants and an organic acid, salt and/or inorganic salt. The surfactants are for instance dihydroxyl alkyl glycinate, alkyl ampho acetate or propionate, alkyl betaine, alkyl amidopropyl betaine and alkylamino mono- or di-propionates derived from certain waxes, fats and oils. The surfactants are used in conjunction with an inorganic water-soluble salt or organic additives such as phthalic acid, salicylic acid or their salts. Amphoteric/zwitterionic surfactants, in particular those comprising a betaine moiety are useful at temperature up to about 175Â° C. and are therefore of particular interest for medium to high temperature wells. However, like the cationic viscoelastic surfactants mentioned above, in absence of a co-additive, they are usually not compatible with high brine concentration.

Some betaine surfactants are particularly useful in forming aqueous gels of exceptional thermal stability in any electrolyte concentration; these materials will form gels with no added salt or even in heavy (high-density) brines. Their compatibility with heavy brines at unexpectedly high temperatures is an important feature of the present invention. Two preferred examples are betaines called, respectively, BET-O and BET-E. The surfactant BET-O-30 is shown below and may be obtained from Rhodia, Inc. Cranbury, N.J., U. S. A. The O indicates that it contains an oleyl acid amide group (including a C₁₇H₃₃ alkene tail group) and the 30 indicia refers to a concentration of active surfactant of about 30%; the remainder being substantially water, sodium chloride, and propylene glycol. An analogous material, BET-E-40, is also available from Rhodia, contains a erucic acid amide group (including a C₂₁H₄₁ alkene tail group) and is 40% active ingredient, with the remainder substantially water, sodium chloride, and isopropanol. The surfactant in BET-E-40 is also shown below. BET surfactants, and others, are described in U.S. Pat. No. 6,258,859. According to that patent, cosurfactants may be useful in extending the brine tolerance, and to increase the gel strength and to reduce the shear sensitivity of the VES-fluid, especially for BET-O. An example given in U.S. Pat. No. 6,258,859 is sodium dodecylbenzene sulfonate (SDBS). Other suitable cosurfactants for BET-O-30 are certain chelating agents such as trisodium hydroxyethylethylenediamine-triacetate.

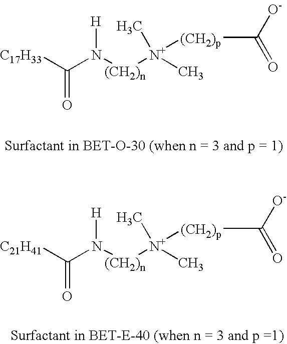

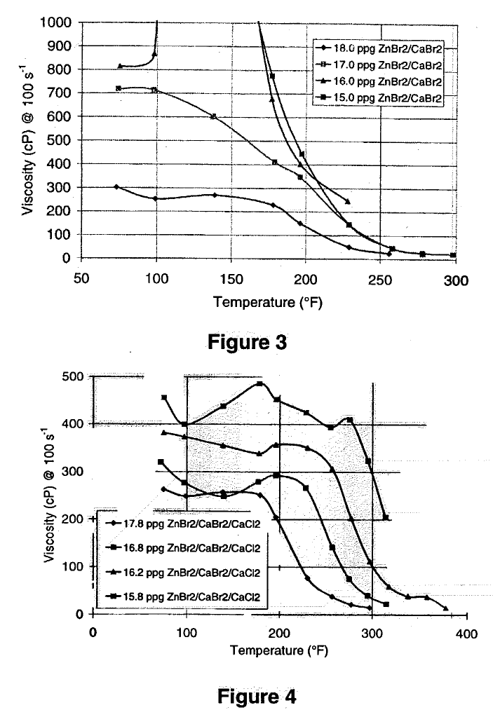

As shown in FIGS. 2 to 4, with BET-E, high-density brine can be made from metal halide (KCl, CaBr₂, CaCl₂, ZnBr₂âetc), chelants (EDTA, EDTA metal saltsâetc), sequesters (phosphates, polyphosphatesâetc), other inorganic metal salts like K₂CO₃, K₂SO₄âand organic salts such as formates and acetates.

In addition, an increase of the density of the base fluid leads to better proppant suspension since the proppant settling velocity is generally proportional to the density difference of the proppant and carrier fluid. As described by Novotny equation, proppant settling in a power-law fracturing fluid is Uₛₒₗ=(1-fᵥ)^{\hat{l}2}[(\ddot{l}□ₛₒₗ−\ddot{l}□ₜ)gdⁿ⁺¹/(3ⁿ⁻¹18K″)]^{1/n}

Where: \hat{l}²=proppant settling velocity

fᵥ=volume fraction of proppant

\ddot{l}□ₛₒₗ=proppant density

\ddot{l}□ₜ=fluid density

n, K″=power law parameters

d=proppant particle diameter

Assuming same parameters of \hat{l}², fᵥ, n, K″ and d, we will have Uₛₒₗâ(\ddot{l}□ₛₒₗ−\ddot{l}□ₜ)^{1/n}. For a case of 3.0SG proppant and n=0.5 fracturing fluid, relationship of proppant settling velocity in different density fracturing fluids is calculated in table 1.

| | |
|---|---|
| | [symbol] |
| | [symbol] |
| | [symbol] |
| [symbol] | [symbol] |

From above calculation, the proppant settling velocity in high density VES fluid of this invention is much lower than that in traditional water-based polymeric fracturing fluids. Note that to be useful, a system shall not only allow the use of high density, but it shall also be stable and not segregate into different phases or layers.

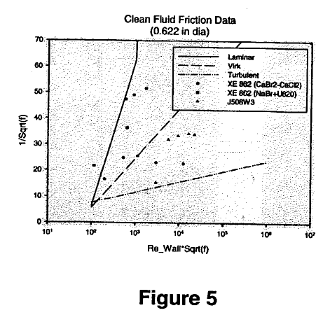

Moreover, viscoelastic based fracturing fluids have great advantages over polymer-based fluids with respect to friction pressure. For instance, friction pressure data through a pipe having a diameter of 0.622 inches were measured for fluids containing 10% betaine in heavy brines. As a comparison data for a viscoelastic gel containing 3% cationic surfactant in 8.5 ppg KCl are plotted and shown in FIG. 5. The data obtained for water superimpose with the turbulent line. Despite the high density of the base fluid, the gels containing 10% of betaine exhibit a beneficial behavior in terms of friction pressure.

The combination of low friction pressure and high hydrostatic pressure makes it possible to pump a job at limited surface pressure and consequently with less hydraulic horsepower. This is shown by the following examples reported in Table 2.e and high hydrostatic pressure makes it possible to pump a job at limited surface pressure, and consequently with less hydraulic horsepower. This is shown by the following examples reported in table 2.

[symbol]

BLE · 2¶

| | Unites [symbol] | Test · 1 [symbol] | Test · 2 [symbol] | Test · 3 [symbol] | Test · 4 [symbol] | [symbol] |
|---|---|---|---|---|---|---|
| [symbol] pth [symbol] | ft [symbol] | 19000 [symbol] | 12000 [symbol] | 7500 [symbol] | 27500 [symbol] | [symbol] |
| [symbol] id · density [symbol] | g/cm² [symbol] | 1.02 [symbol] | 1.02 [symbol] | 1.02 [symbol] | 1.02 [symbol] | [symbol] |
| pe · ID [symbol] | In [symbol] | 2.441 [symbol] | 1.282 [symbol] | 1.532 [symbol] | 2.991 [symbol] | [symbol] |
| te [symbol] | bpm [symbol] | 20 [symbol] | 80 [symbol] | 10 [symbol] | 30 [symbol] | [symbol] |
| [symbol] Grad [symbol] | Psi/ft [symbol] | 0.85 [symbol] | 0.90 [symbol] | 0.80 [symbol] | 0.70 [symbol] | [symbol] |
| [symbol] ction [symbol] | Psi/100 ft [symbol] | 550 [symbol] | 1200 [symbol] | 850 [symbol] | 625 [symbol] | [symbol] |
| urf · l [symbol] | Psi [symbol] | 18208 [symbol] | 19900 [symbol] | 9063 [symbol] | 24292 [symbol] | [symbol] |
| urf · max [symbol] | Psi [symbol] | 15000 [symbol] | 15000 [symbol] | 7000 [symbol] | 15000 [symbol] | [symbol] |
| IP [symbol] | Psi [symbol] | 16150 [symbol] | 10800 [symbol] | 6000 [symbol] | 19250 [symbol] | [symbol] |
| duction · [symbol] | [symbol] | 17% [symbol] | 24% [symbol] | 23% [symbol] | 38% [symbol] | [symbol] |
| [symbol] 1410justed fluid | g/cm² [symbol] | 1.41 [symbol] | 1.96 [symbol] | 1.66 [symbol] | 1.8 [symbol] | [symbol] |
| [symbol] uity [symbol] | | | | | | |

Test 1 is representative of a fairly standard case. The fracturing fluid being injected combines very low friction losses with the increase in fluid density (from 1.02 to 1.41 g/cm³) and makes it possible to reach the required bottomhole pressure of 16,150 psi while maintaining the surface pressure below the limit of 15,000 psi (Psurf max), or a reduction in surface pressure needs of 17%. Test 2 is an example where the friction losses are high due to the use of a small string of pipe, resulting in high surface treating pressure. The use of a high-density fluid according to the invention reduces the surface pressure by 24%, making it possible to successfully fracture the well. Test 3 shows the invention allows the use of standard coiled tubing unit where a high-pressure coiled tubing unit (above 7000 psi) would have been required with standard water-based fluid density. Though the reduction in surface pressure needs is only of 23%, the use of standard equipment significantly reduces the cost of the job. Finally Test 4 is an example of well in an offshore deepwater environment, where the significant length of the pipe makes high-density fluid critical in being able to effectively stimulate the wells.

The high-density fluid of the present invention may also be helpful for controlling the growth of the fracture. This technique may be in particular useful where the pay zone containing oil or gas is closed to a water-zone and care must be taken to avoid a fracture growth into the water. In this case, the pad treatment and the initial fracturing job may be performed with a fluid of high density but of relatively low viscosity. The lower viscosity results in less net pressure (bottomhole pressure minus fracture closure pressure), which prevents undesired hydraulic fracture growth into the water-bearing zone. The same benefit can also be realized if fracture-stimulating an interval just below a gas cap where production of the gas is undesirable at the time.

1. A method of fracturing a subterranean formation including injecting into a wellbore a fracturing fluid based on a liquid medium having a density higher than 1.3³, thereby allowing the use of a surface pressure at least 10% smaller than the surface pressure required with a fracturing fluid based on a liquid medium having a density of about 1³.

2. The method of claim 1, wherein the liquid medium density is greater than 1.4³.

3. The method of claim 1, wherein the liquid medium density is greater than 1.8³.

4. The method of claim 1, wherein the surface pressure is kept below 15,000(103.4during the injection.

5. The method of claim 1, wherein the injection is performed with a coiled tubing unit and the surface pressure is kept below 7,000 psi (48.3 MPa) during the injection.

6. The method of claim 1, wherein the liquid medium comprises an aqueous solution, a zwitterionic surfactant as gelling agent and salts.

7. The method of claim 6, wherein said zwitterionic surfactant is a betaine containing a oleyl acid amide group.

8. The method of claim 7, wherein the aqueous solution further comprises at least one gel stabilizer selected from the list consisting of co-surfactant or hydroxyethylaminocarboxylic acid.

9. The method of claim 6, wherein said zwitterionic surfactant is a betaine containing an erucic acid amide group.

10. The method of claim 1, wherein the fluid comprises at least a salt selected from the group consisting of calcium chloride, calcium bromide, potassium bromide, sodium bromide and mixture thereof.

11. A method of fracturing a subterranean formation including injecting into a wellbore a fracturing fluid based on a liquid medium having a density higher than 1.3³, thereby allowing the use of a surface pressure not greater than 15,000 psi during the whole injection, adding proppant and energizing the fluid.
